(19) United States
(12) Patent Application Publication
(10) Pub. No.: US 2020/0125653 A1
(43) Pub. Date: Apr. 23, 2020

(54) ROBUST FAULT DETECTION AND DIAGNOSISON DYNAMIC SENSOR NETWORK

(71) Applicant: General Electric Company, Schenectady, NY (US)

(72) Inventor: Hao HUANG, San Ramon, CA (US)

(21) Appl. No.: 16/166,597

(22) Filed: Oct. 22, 2018

(51) Int. Cl. G06F 17/30; G01D 9/00

(52) U.S. Cl. CPC G06F 17/30321; G01D 9/00

(57) ABSTRACT

A method of analyzing time-series data includes accessing time-series data of one or more components of an industrial asset, selecting a period of interest from the time-series data. For each of the one or more components, calculating a first iteration of an eigen-value matrix, then calculating a rank-k eigen vector based on each element of the first iteration eigen-value matrix, after calculating the rank-k eigen vector for each first iteration eigen-value matrix, then for each element in the rank-k eigen vector calculating a second iteration eigen-value matrix. Then calculating a fault score for the selected period of interest, and calculating a root-cause indicator vector for the selected period of interest. Generating graphical representations of both the fault score and root-cause indicator. Providing in the graphical representations visual indications of fault regions and root-cause components above a predetermined threshold. A system and a non-transitory computer-readable medium are also disclosed.

### BACKGROUND

Effective data-driven analytics is possible using advancements in sensor technologies and networked industrial machinery design. Fault detection and the corresponding root cause analysis (diagnosis) is especially critical to todays' industrial society. Conventional approaches monitor dynamic sensor networks and detect short and/or long term change.

In modern complex systems, fault often starts from a few certain components and propagates to the other components. Such propagation often lasts for a certain time with a relatively stable pattern. A time series graph of a dynamic network can represent the components and their interrelationships at certain timestamps. A graph node represents a system component and an edge represents the recent relationship between its two connected nodes. Early failure warning and system diagnoses can be achieved by analyzing the time series graph to identify 1) any stable changes (fault propagation) in the graph structure across time; and 2) the root cause of this change.

Conventional systems and methods focus too much attention on a sudden change in the graph sequence (which can result from a mode switch that is usually of no interest), or fail to capture any stable propagation pattern in the presence of noise. What is missing from the art is a system that can analyze the time series graph to measure the degree of stable change and its corresponding root cause.

### BRIEF DESCRIPTION OF THE DRAWINGS

FIG. 1 depicts an illustration of fault propagation in three consecutive timestamps;

FIG. 2 depicts a fault score plot detected by an embodying algorithm from an experimental dataset in accordance with embodiments;

FIG. 3 depicts a root cause indicator detected by an embodying algorithm from an experimental dataset in accordance with embodiments;

FIG. 4 depicts a process of analyzing time series data to determine a fault score and identify root cause indicator in accordance with embodiments; and

FIG. 5 depicts a system for analyzing time series data to determine a fault score and identify root cause indicator in accordance with embodiments.

### DESCRIPTION

Embodying systems and methods provide for the suppression of noise effects to capture a time series graph change occurring during a certain period, and its corresponding root cause (i.e., contributing component(s)). Embodying approaches optimize a matrix-based Taylor expansion equation to suppress the noise effect. Embodying systems and methods can determine a temporal fault propagation model (if present in the time series data) by analyzing the time series graph. Through extensive experimentation using both synthetic datasets and real world (i.e., captured/monitored) datasets an embodying Robust Fault Detection and Diagnosis (RoFaD) algorithm is consistently more effective than conventional approaches.

An embodying RoFaD algorithm can detect a fault occurrence from its starting timestamp to the occurrence's end, and identify the fault's root cause component. Because correlations between components are usually dynamic, an embodying RoFaD algorithm is adaptive and operates in about real time to detect and analyze fault. An embodying RoFaD algorithm can find underlying propagation patterns in real world data despite the presence of constant noise in the data.

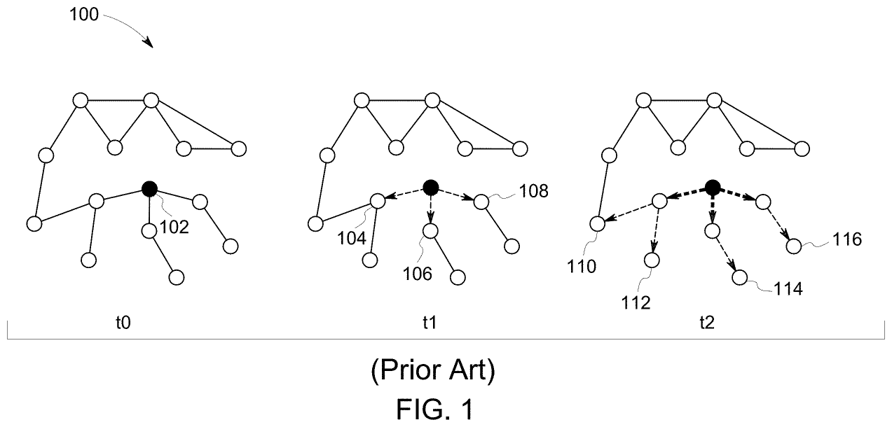

FIG. 1 illustrates fault propagation data 100 in three consecutive timestamps. Each node represents one component and each edge interconnecting nodes represents a correlation between the two components. At timestamp t0 a fault starts at component 102. At timestamp t1 the fault propagated to correlated components 104, 106, 108. At timestamp t2 fault propagation has reached correlated components 110, 112, 114, 116. The arrows indicate the propagation direction; wider edge lines indicate the effect of the fault (e.g., the fault at component 102 has more of an effect on components 104, 106, 108 than the fault had on components 110, 112, 114, 116).

The following notations are used in this disclosure:

For a matrix Z∈ [symbol] ^{m×n}:

Z^{j} (with j>0) denotes as the matrix product of j copies of Z; and

Z⁻¹ denotes the matrix's (pseudo)inverse;

Z(i,j) denotes the element in the i-th row and j-th column; and

Z(i, :) and Z(:,j) denote the matrix's i-th row and j-th column respectively.

Entry-wise norms are denoted by ∥Z∥ₚ:

Where when p=2 gives Frobenius norm ∥Z∥_{F}=\sqrt{ΣᵢⱼZ(i,j)²}=\sqrt{tr(ZZ^{T})}; and

p=(2,1) gives [symbol] _{2,1} norm ∥Z∥_{2,1}=Σᵢ₌₁^{m} ∥Z(i,:)∥₂.

The infinity norm of Z is denoted by ∥Z∥_{∞} where ∥Z∥_{∞}=max_{1≤i≤m}Σⱼ₌₁ⁿ|Z(i,j)|.

For a vector [w₁, . . . , wₘ]∈ [symbol] ^{m×1}:

diag([w₁, . . . , wₘ])∈ [symbol] ^{m×m} denotes a diagonal matrix with w₁, . . . , wₘ as its diagonal entries;

diag(Z) for a given square matrix Z is a square matrix that has the same diagonal entries as Z but off-diagonal entries are all zeros.

[symbol] ₘ is an identity matrix of dimension m×m.

In accordance with embodiments, the RoFaD algorithm can operate with the following assumptions:

(1) Given a time series of graph A_{[t-h+1:t]}=[Aₜ₋ₕ₊₁, Aₜ₋ₕ₊₂, . . . , Aₜ] (Aⱼ∈ [symbol] ^{m×m}) where a fault propagation starts as t−h+1 and ends at t, there exists a symmetric and full rank fault propagation matrix P∈ [symbol] ^{m×m} that is stable across time [t−h+1, t]. This propagation matrix can be expressed by Equation 1.

Aⱼ=Aⱼ₋₁P, or (Aⱼ₋₁)⁻¹Aⱼ=P, (EQ. 1)

Where t−h≤j≤t. Note that there is no normalization performed on Aⱼ or P.

(2) Because P is symmetric, from P can be obtained a rank-k eigen-vector U∈ [symbol] ^{m×k} and an eigen-value matrix S∈ [symbol] ^{k×k} from P by application of Equation 2.

P=USU⁻¹, or [U,S]=eig(P,k), (EQ. 2)

The corresponding ∈ [symbol] ^{m×1} can be measured by Equation 3.

rⱼ=Σᵢ₌₁^{k}|US|ⱼᵢ, (EQ. 3)

Where rⱼ indicates the degree of fault of the j-th component. Furthermore, given that the pattern of fault propagation is usually stable within a certain time period, the fault score for the whole graph series A_{[t-h+1:t]} can be measured by Equation 4.

$$c = {max}_{j} ( {r}_{j} / {\sum }_{i = 1}^{m} {r}_{i} ) . \qquad ( EQ . 4 )$$

An embodying RoFaD algorithm can obtain both root cause indicator metric r and fault score c from the graph series A_{[t-h+1:t]}. An embodying RoFaD algorithm can overcome the real world effect of ever-present noise. This noise can affect the real measurement of every graph Aⱼ in the time series.

Assume that an observation of Aⱼ is Ãⱼ, and that Ãⱼ=Aⱼ+Qⱼ (EQ. 5);

Where Qⱼ∈ [symbol] ^{m×m} is a local noise matrix at time j, and it is independent and identically distributed. Since Ã_{[t-h+1:t]}=[Ãₜ₋ₕ₊₁, Ãₜ₋ₕ₊₂, . . . , Ãₜ] are symmetric, Q_{[t-h+1:t]}=[Qₜ₋ₕ₊₁, Qₜ₋ₕ₊₂, . . . , Qₜ] is also symmetric.

Due to the existing of unknown noise, there is no straightforward way to obtain P from the temporal observation Ã_{[t-h+1:t]} (since Ãⱼ₋₁⁻¹Ãⱼ is not stable across time). Embodying approaches can implement an alternative way to optimize P (Equation 6).

$${min}_{P} {\sum }_{j = t - h + 1}^{t} {‖ P - {( {\tilde{A}}_{j - 1} )}^{- 1} {\tilde{A}}_{j} ‖}_{F}^{2} . \qquad ( EQ . 6 )$$

Given the existence of noise, to get the most recent value of P at time t by Equation 6 (assume that P is stable from time t−h+1 to t), an intuition would be that the most recent graphs (e.g., Ãₜ) would be more reliable than the earlier graphs (e.g., Ãₜ₋ₕ₊₁) in the time series. A mathematical combination of Equation 1 and Equation 5 results in Equation 7.

$$( {\tilde{A}}_{t - j} - {Q}_{t - j} ) {P}^{j} = {\tilde{A}}_{t} - {Q}_{t} , \\ Thus , \\ {‖ {{P}^{j} ( {\tilde{A}}_{t - j} )}^{- 1} {\tilde{A}}_{t} ‖}_{F}^{2} = {‖ {( {\tilde{A}}_{t - j} )}^{- 1} {Q}_{t - j} {P}^{j} - {( {\tilde{A}}_{t - j} )}^{- 1} {Q}_{t} ‖}_{F}^{2} \leq {‖ {( {\tilde{A}}_{t - j} )}^{- 1} {Q}_{t - j} {P}^{j} ‖}_{F}^{2} + ‖ {( {\tilde{A}}_{t - j} )}^{- 1} {Q}_{t} ‖ \leq {‖ {( {\tilde{A}}_{t - j} )}^{- 1} ‖}_{F}^{2} {‖ {Q}_{t - j} ‖}_{F}^{2} {‖ {P}^{j} ‖}_{F}^{2} + {‖ {( {\tilde{A}}_{t - j} )}^{- 1} ‖}_{F}^{2} {‖ {Q}_{t} ‖}_{F}^{2} \leq {m}^{4} {‖ P ‖}_{F}^{2 j} + {m}^{4} \qquad ( EQ . 7 )$$

The error magnitude is in direct relationship with j (i.e., the error increases as j increases). To suppress the cumulative error by time, instead of optimizing P using Equation (6), embodying approaches can implement Equation 8.

$${min}_{p} {\sum }_{j = 0}^{h - 1} f ( j ) {‖ {P}^{j} - {( {\tilde{A}}_{t - j} )}^{- 1} {\tilde{A}}_{t} ‖}_{F}^{2} , \qquad ( EQ . 8 )$$

Where f(j) is a smoothing/weighting function that is decreasing as j increases. By setting

$$f ( j ) = \frac{1}{j !} ,$$

Equation 8 can be rewritten as Equation 9.

$${min}_{P} {\sum }_{j = 0}^{h - 1} {‖ \frac{{P}^{j}}{j !} - \frac{1}{j !} {( {\tilde{A}}_{t - j} )}^{- 1} \tilde{{A}_{t}} ‖}_{F}^{2} . \qquad ( EQ . 9 )$$

According to the power series theorem,

$${e}^{P} = {\sum }_{j = 0}^{∞} \frac{{P}^{j}}{j !} ,$$

by combining with the matrix exponential of P, Equation 9 can be expressed as

$${min}_{P} {‖ {e}^{P} - {\sum }_{j = 0}^{h - 1} \frac{1}{j !} {( {\tilde{A}}_{t - j} )}^{- 1} \tilde{{A}_{t}} - {\sum }_{j = h}^{∞} \frac{{P}^{j}}{j !} ‖}_{F}^{2} .$$

If it is assumed that h is chosen such that

$${‖ {\sum }_{j = h}^{∞} \frac{{P}^{j}}{j !} ‖}_{F}^{2} < ɛ ; \qquad ( Equation 10 )$$

where ϵ is an error bound.

In accordance with embodiments,

$${min}_{P} {‖ {e}^{P} - {\sum }_{j = 0}^{h - 1} \frac{1}{j !} {( {\tilde{A}}_{t - j} )}^{- 1} {\tilde{A}}_{t} ‖}_{F}^{2} \qquad ( Equation 11 )$$

can be minimized so that instead of solving for the propagation matrix P, embodying systems and methods can solve eigen-vector matrices U and S directly to obtain root cause indicator r and fault score c. Because propagation matrix P is a symmetric, full ranked matrix, there is a Jordan canonical form of P:

e^{P}=Ue^{S}U⁻¹ (EQ. 12)

The objective loss function represented by Equation 13 can be designed by letting

$$\hat{A} = {( {\sum }_{j = 0}^{h - 1} \frac{1}{j !} {( {\tilde{A}}_{t - j} )}^{- 1} {\tilde{A}}_{t} )}^{\frac{1}{2}} and s = diag ( {( {e}^{S} )}^{\frac{1}{2}} ) . \\ ( U , s ) = {min}_{U , s} {‖ Udiag ( s ) - \hat{A} ‖}_{F}^{2} + α {‖ U ‖}_{2 , 1} + β {‖ s ‖}_{1} . \qquad ( EQ . 13 )$$

Because it is verifiable that the loss function [symbol] is jointly convex in U and s, a global optimal solution exists. To reduce cumulative error when solving EQ. 13, in some implementations the length of the time series is restricted to less the 10 units of time.

The optimization of both U and s simultaneously is difficult. In accordance with embodiments, Equation 13 can be solved with an iterative solution. Embodying approaches adopt an alternating and iterative optimization procedure to solve practical optimization problems.

Given s, the optimal U can be computed by minimizing the objective function of Equation 14.

$$( U ) = {min}_{U} {‖ Udiag ( s ) - \hat{A} ‖}_{F}^{2} + α {‖ U ‖}_{2 , 1} . \qquad ( EQ . 14 )$$

For a constant value of s, each iteration of U can be obtained by Equation 15.

U(i,:)=R(i,:)(T+αD_{U}(_{i,i}) [symbol] ₘ)⁻¹,1≤i≤m (EQ. 15)

Where R=Âdiag(s);

T=diag(s)²; and

D_{U} is a diagonal matrix with the i-th diagonal element as

$${D}_{U} ( i , i ) = \frac{1}{2 {‖ U ( i , : ) ‖}_{2}} .$$

Given U, the optimal s can be computed by minimizing the objective function of Equation 16.

$$( s ) = {min}_{s} {‖ Udiag ( s ) - \hat{A} ‖}_{F}^{2} + β {‖ s ‖}_{1} . \qquad ( EQ . 16 )$$

For a constant value of U, each iteration of s can be obtained by Equation 17.

$${s}_{i} = ( \begin{matrix}\frac{2 {U ( : , i )}^{T} \hat{A} ( : , i ) - β}{2 {U ( : , i )}^{T} U ( : , i )} & if \frac{2 {U ( : , i )}^{T} \hat{A} ( : , i ) - β}{2 {U ( : , i )}^{T} U ( : , i )} > 0 \\ \frac{2 {U ( : , i )}^{T} \hat{A} ( : , i ) + β}{2 {U ( : , i )}^{T} U ( : , i )} & if \frac{2 {U ( : , i )}^{T} \hat{A} ( : , i ) + β}{2 {U ( : , i )}^{T} U ( : , i )} < 0 \\ 0 & otherwise\end{matrix} \qquad ( EQ . 17 )$$

In accordance with embodiments, the time complexity of each iteration is 0(m²h) and space complexity is 0(m²h), where m is the number of components in the system (i.e., number of nodes in each graph), and h is the length of the time series section. An embodying RoFaD algorithm outputs one fault score c and one root cause indication r for each input time series section. The elements in r are positive, where a higher value indicates a greater possibility of a corresponding component being the fault's root cause.

An embodying RoFaD algorithm can be expressed as shown in TABLE 1.

TABLE I

```
INPUT: A section of a time series graph
  Ã_{[t-h+1:t]} = [Ãₜ₋ₕ₊₁, . . . , Ãₜ] (Ãⱼ ∈ [symbol] ^{m×m}
  where t − h + 1 ≤ j ≤ t and m is
  #components(sensors)), the number of low rank
  k, the scales of regularization terms α and β.
OUTPUT: A fault score c and one root cause indication
vector r ∈ [symbol]  ^{m×1}.
$1 Calculate \hat{A} = {( {\sum }_{j = 0}^{h - 1} \frac{1}{j} {( {\tilde{A}}_{t - j} )}^{- 1} {\tilde{A}}_{t} )}^{\frac{1}{2}} ;$
2 Initialize U and S by [U, S] = eig (Â, k);
3 Initialize s by s = diag (S);
4 while Not Convergent do
5 Calculate U using Eq (15);
6 Calculate s using Eq (17);
7 end while;
8 Calculate r using Eq (3);
9 Calculate c using Eq (4).
```

In accordance with embodiments, the value of h can be selected. In Equation 10, the Taylor truncation error is bound by ϵ. With E denoting

$${\sum }_{j = h}^{∞} \frac{{P}^{j}}{j !}$$

the following inequality is expressed:

$${‖ E ‖}_{F}^{2} = {\sum }_{ij} {E ( i , j )}^{2} \leq {m ( {max}_{1 \leq i \leq m} {\sum }_{j = 1}^{m} \vert E ( i , j ) \vert )}^{2} = m {‖ E ‖}_{∞}^{2} .$$

Where ∥E∥_{∞}, is bounded by

$${‖ E ‖}_{∞} \leq \frac{{‖ P ‖}_{∞}^{h} ( h + 2 )}{( h + 1 ) ! ( h + 1 )} .$$

### Therefore,

$$ɛ > {‖ E ‖}_{F} \leq \sqrt{m} {‖ E ‖}_{∞} \leq \sqrt{m} \frac{{‖ P ‖}_{∞}^{h} ( h + 2 )}{( h + 1 ) ! ( h + 1 )} .$$

Thus, in implementations of an embodying RoFaD algorithm, a choice for h should not be smaller than \sqrt{m}∥P∥_{∞}log(1/ϵ).

An embodying RoFaD algorithm underwent experimental testing using a real world dataset of sensor data. This real world dataset was collected over a sixty day period from sensors on a complicated machine with forty different components. For each data collection day, the correlation between every pair of component was measured and used to build a graph on the forty components. Therefore the input dataset is a time series graph Ã∈ [symbol] ^{40×′×60}.

For this analysis, the following were the parameter settings: h=4, k=1, a=1 and β=1.

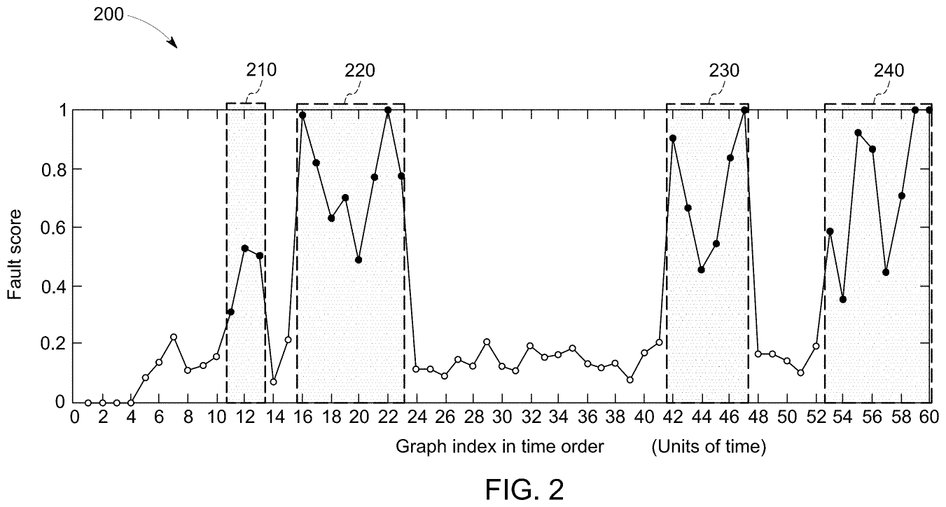

FIG. 2 depicts plot 200 illustrating the fault score c of the experimental dataset detected by an RoFaD algorithm in accordance with embodiments. For implementation of the experiment, the scorethreshold=0.3. Inspection of plot 200 indicates that the time series dataset has four faults regions 210, 220, 230, 240. These four faults occur at the 11th, 16th, 42nd, and 53rd time stamps.

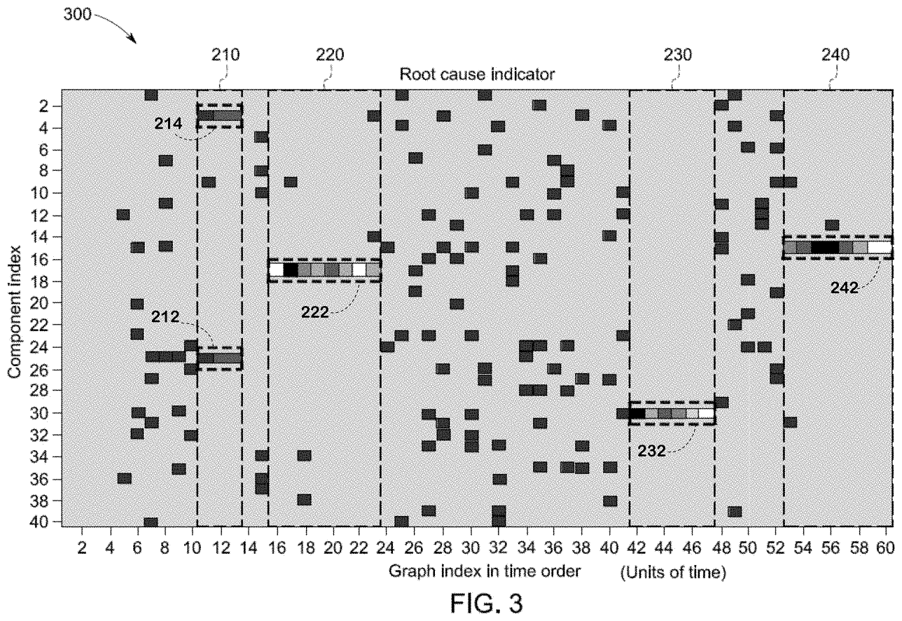

FIG. 3 depicts graph 300 indicating root cause indicator r for the experimental dataset detected by an RoFaD algorithm in accordance with embodiments. The embodying RoFaD algorithm identifies components 212, 214, 222, 232, 242 within faults regions 210, 220, 230, 240. Components 212, 214, 222, 232, 242 are the root cause of the corresponding fault. Examination of graph 300 indicates that the root cause components obtained by the embodying RoFaD algorithm are stable in each fault propagation process.

The results of the embodying RoFaD algorithm was verified by an expert in the domain of the machine used to collect the experimental dataset. After performing an analysis of the experimental dataset, the domain expert verified that the embodying RoFaD algorithm successfully detected all faults (i.e., 4) and their root cause components (i.e., 5) within the timeseries data set over the sixty day period.

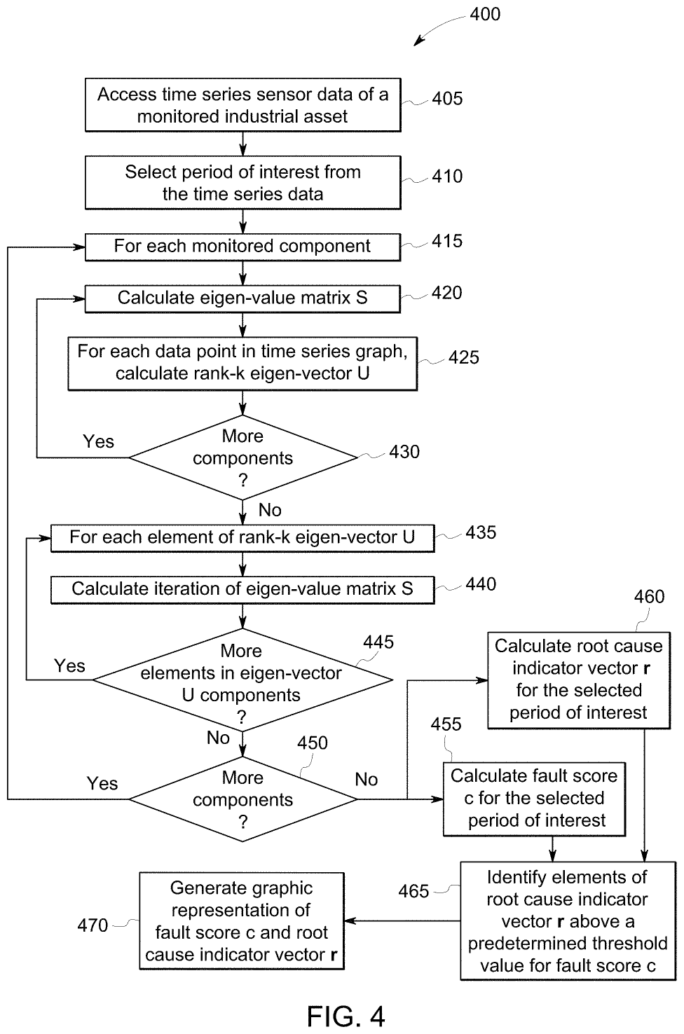

FIG. 4 depicts process 400 of implementing a RoFaD algorithm of analyzing time series data to determine a fault score and identify root cause indicator in accordance with embodiments. Time series data of a monitored industrial asset is accessed, step 405. The time series data can represent sensor data from sensors distributed within the industrial asset that are monitoring parameters of the industrial asset's operation (e.g., (as applicable) temperature, fluid pressure, voltage, revolution per minute, etc.). A time period of interest is selected, step 410, from the time series data. The selected portion can be a subset or all of the time series data.

Embodying approaches apply an alternating and iterative optimization procedure to a rank fault propagation matrix representing the time series data. For each monitored component represented in the time series data, (step 415), an element in eigen-value matrix S is calculated (EQ. 17), step 420. For each data point in the selected portion of the time series graph, process 400 calculates rank-k eigen-vector U (EQ. 15), step 425. At step 430, a determination is made whether there are more components. If there are more components, process 400 returns to step 420, else it proceeds to step 435.

At step 435, this alternating and iterative optimization procedure continues for each element of the rank-k eigen-vector U. An iteration of eigen-value matrix S is calculated, step 440. At step 445, a determination is made whether there are more elements in U. If there are more elements, process 400 returns to step 435, else it proceeds to step 450.

At step 450, a determination is made whether there are more monitored component data points in the selected time series data. If there are more monitored component data points, process 400 returns to step 415, else it proceeds to steps 455 and 460.

A fault score for the selected period of interest is calculated (EQ. 4), step 455. Also, elements of root cause indicator vector r are calculated (EQ. 3), step 460. Elements of the root cause indicator vector above a predetermined fault score threshold value are identified, step 465. Graphical representations of the fault score and the root cause indicator are generated.

The fault score graphical representation can include the selected time series data and a visual indication of any fault regions within the selected time series data that is above a predetermined threshold. FIG. 2 illustrates an embodying representation with visual indication of fault regions. The root cause indicator graphical representation can include an indication of components identified by the RoFaD algorithm as being root cause components within the fault regions indicated in the fault score graphical representation. FIG. 3 illustrates an embodying representation with visual indication of root cause components with the fault regions.

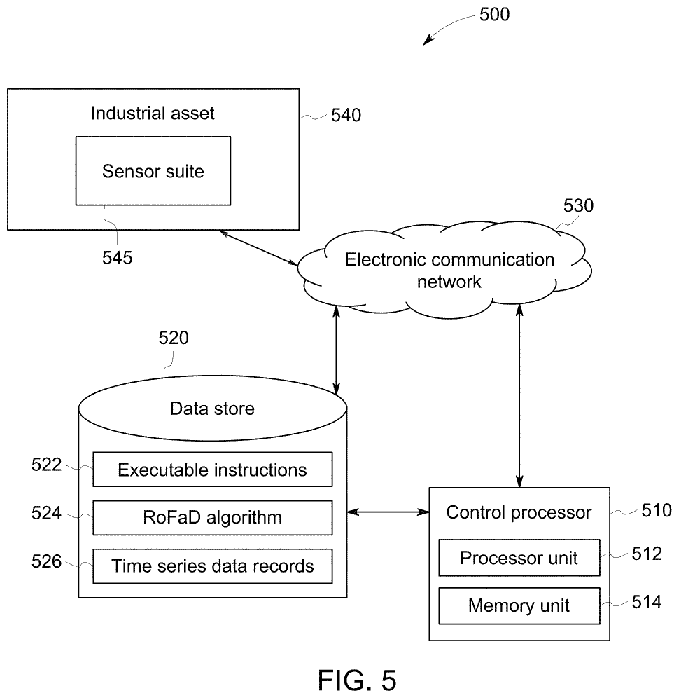

FIG. 5 depicts system 500 for analyzing time series data to determine a fault score and identify root cause indicator in accordance with embodiments. System 500 can include control processor 510 in communication with data store 520. The control processor can be in direct communication with the data store, or in indirect communication across electronic communication network 530. Processor unit 512 can execute executable instructions 522, which cause the processor to perform RoFaD algorithm 524. Memory unit 514 can provide the control processor with local cache memory. Data store 520 can include time series data records 526. The time series data can be received from industrial assets 540 across electronic communication network 530. Each industrial asset including a sensor suite that monitors operating conditions of the industrial asset. The industrial asset can be, for example, a physical asset such as a turbine engine, machinery, turbine generator, industrial equipment, etc.

An embodying RoFaD algorithm implements an online learning method as the algorithm can adapt to concept drift and/or running environment change. The RoFaD algorithm is based on graph theory to analyze time series data and find those gradual changes that starts from certain components/nodes of the graph, then propagates to the rest of the graph's nodes, where such change maintains a stability within a certain period of time. The RoFaD algorithm is robust to any transient change or noise based on sensor readings without the need for controller signals or any information from a controller.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable program instructions that when executed may instruct and/or cause a controller or processor to perform methods discussed herein such as a method of analyzing time series data to determine a fault score and identify root cause indicator, as disclosed above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of analyzing time series data, the method comprising:
accessing time series data of one or more components of an industrial asset;
selecting a period of interest from the time series data;
for each of the one or more components, performing a series of steps including:
calculating a first iteration of an eigen-value matrix;
then calculating a rank-k eigen vector based on each element of the first iteration eigen-value matrix;
after calculating the rank-k eigen vector for each first iteration eigen-value matrix, then for each element in the rank-k eigen vector calculating a second iteration eigen-value matrix;
after completing the series of steps for each of the one or more components, then:
calculating a fault score for the selected period of interest;
calculating a root-cause indicator vector for the selected period of interest;
generating a fault score graphical representation of the selected period of interest; and
generating a root-cause indicator graphical representation for the selected period of interest.

2. The method of claim 1, including the period of interest can be a portion or the entirety of the accessed time series data.

3. The method of claim 1, including the time series data representing monitored operating conditions obtained from sensors of the industrial asset.

4. The method of claim 1, including representing the time series data in a rank fault propagation matrix.

5. The method of claim 1, including providing a visual indication of fault regions in the fault score graphical representation.

6. The method of claim 1, including providing a visual indication of a root-cause component in the root-cause indicator graphical representation.

7. The method of claim 6, including selecting the root-cause component by comparing at least one element of the root-cause indicator vector to a predetermined threshold.

8. A non-transitory computer-readable medium having stored thereon instructions which when executed by a control processor cause the control processor to perform a method of analyzing time series data, the method comprising:
accessing time series data of one or more components of an industrial asset;
selecting a period of interest from the time series data;
for each of the one or more components, performing a series of steps including:
calculating a first iteration of an eigen-value matrix;
then calculating a rank-k eigen vector based on each element of the first iteration eigen-value matrix;
after calculating the rank-k eigen vector for each first iteration eigen-value matrix, then for each element in the rank-k eigen vector calculating a second iteration eigen-value matrix;
after completing the series of steps for each of the one or more components, then:
calculating a fault score for the selected period of interest;
calculating a root-cause indicator vector for the selected period of interest;
generating a fault score graphical representation of the selected period of interest; and
generating a root-cause indicator graphical representation for the selected period of interest.

9. The non-transitory computer-readable medium of claim 8, the instructions further configured to cause the control processor to perform the method, including the period of interest being a portion or the entirety of the accessed time series data.

10. The non-transitory computer-readable medium of claim 8, the instructions further configured to cause the control processor to perform the method, including the time series data representing monitored operating conditions obtained from sensors of the industrial asset.

11. The non-transitory computer-readable medium of claim 8, the instructions further configured to cause the control processor to perform the method, including representing the time series data in a rank fault propagation matrix.

12. The non-transitory computer-readable medium of claim 8, the instructions further configured to cause the control processor to perform the method, including providing a visual indication of fault regions in the fault score graphical representation.

13. The non-transitory computer-readable medium of claim 8, the instructions further configured to cause the control processor to perform the method, including providing a visual indication of a root-cause component in the root-cause indicator graphical representation.

14. The non-transitory computer-readable medium of claim 13, the instructions further configured to cause the control processor to perform the method, including selecting the root-cause component by comparing at least one element of the root-cause indicator vector to a predetermined threshold.

15. A system for analyzing time series data, the system comprising:
a control processor in communication with a data store across an electronic communication network, the control processor including a processor unit;
the data store including executable instructions and time series data records representing monitored conditions of one or more components of an industrial asset;
the executable instructions when executed by the processor unit cause the processor unit to perform a method comprising:
accessing the time series data records;
selecting a period of interest from the time series data;
for each of the one or more components, performing a series of steps including:
calculating a first iteration of an eigen-value matrix;
then calculating a rank-k eigen vector based on each element of the first iteration eigen-value matrix;
after calculating the rank-k eigen vector for each first iteration eigen-value matrix, then for each element in the rank-k eigen vector calculating a second iteration eigen-value matrix;
after completing the series of steps for each of the one or more components, then:
calculating a fault score for the selected period of interest;
calculating a root-cause indicator vector for the selected period of interest;
generating a fault score graphical representation of the selected period of interest; and
generating a root-cause indicator graphical representation for the selected period of interest.

16. The system of claim 15, the executable instructions configured to cause the processor unit to perform the method, including the time series data representing monitored operating conditions obtained from sensors of the industrial asset.

17. The system of claim 15, the executable instructions configured to cause the processor unit to perform the method, including representing the time series data in a rank fault propagation matrix.

18. The system of claim 15, the executable instructions configured to cause the processor unit to perform the method, including providing a visual indication of fault regions in the fault score graphical representation.

19. The system of claim 15, the executable instructions configured to cause the processor unit to perform the method, including providing a visual indication of a root-cause component in the root-cause indicator graphical representation.

20. The system of claim 19, the executable instructions configured to cause the processor unit to perform the method, including selecting the root-cause component by comparing at least one element of the root-cause indicator vector to a predetermined threshold.
